(19) United States
(12) Patent Application Publication
(10) Pub. No.: US 2003/0003814 A1
(43) Pub. Date: Jan. 2, 2003

(54) Circuit for dividing or bringing together high-frequency performances

(76) Inventors: Thomas Haunberger, Bad Reichenhall (DE); Franz Pichler, Raubling (DE); Manuel Lund, Prutting (DE)

Correspondence Address: Nixon & Vanderhye, 8th Floor, 1100 North Glebe Road, Arlington, VA, 22201-4714, US

(21) Appl. No.: 10/181,474

(22) PCT Filed: Jan. 18, 2001
(86) PCT No.: PCT/EP01/00551

(30) Foreign Application Priority Data
Jan. 20, 2000 (DE) 100 02 317.7
Sep. 28, 2000 (DE) 200 16 787.7

(51) Int. Cl. H01R 9/22

(52) U.S. Cl. 439/894

(57) ABSTRACT

An improved circuit for splitting or for joining radio-frequency powers, having a main line (7) which is connected between an input port (1) and a first output port (3), and having a branch line (11) which branches off from the main line at a branching point (9) and leads to a second output port (5), is distinguished in that a compensating element (61) is provided which, in particular, is adjustable or can be fitted and removed differently, and which can be varied, varying the capacitance of at least one capacitor (C₁, C₂, C₃) which is connected in the branch line (11), and/or varying the electrical length of a spur line (37) which is coupled to the branch line (11), such that the change in the magnitude of the power which is tapped off also makes it possible to compensate at the same time for the resistance change which is caused by the change in the power split.

The invention relates to a circuit for splitting or joining radio-frequency powers as claimed in the precharacterizing clause of claim 1.

Circuits for splitting or joining radio-frequency powers are known, for example, as so-called bridge circuits or as Wilkinson couplers and are used in particular for connecting radio-frequency transmitters or antennas in parallel, in radio-frequency technology.

A circuit of this generic type for splitting and joining radio-frequency powers has been disclosed, for example, in the prospectus Kathrein-Werke KG “Base Station Antennas for Mobile Communication, catalog 03.99”.

The circuit is arranged, for example, in an elongated housing on one of whose end faces the so-called sum port (input) can be provided and on whose opposite end, for example, a first individual port can be provided, and the second individual port can be provided on a transverse face, adjacent to this end face, but at right angles to it.

The power is split by means of different resistances at the individual port (different individual port resistances connected in parallel). The first individual port in this case remains unchanged. The second individual port is in this case subjected, for example, to λ/4 transformation. In other words, the power split according to the prior art is provided by means of a different impedance z (“λ/4 transformation”). The power division in this case produces a reaction on the input, however. In particular, if the division ratios differ, they cannot be set such that they are variable, so that different types and appliances must be provided for the different power division ratios.

A circuit for splitting or joining radio-frequency powers is known from U.S. Pat. No. 3,324,421, in which a main line is connected between an input port and first output port, and a branch line branches off from the main line at a branching point. An adjustable output element is provided in this circuit, which determines the magnitude of the power tapped off by varying the capacitance of a capacitor which is connected in the branch line. Depending on the measurement frequency, the output element can in this way be adapted over a narrow bandwidth, that is to say only the measurement branch is adapted. This output element causes reactions on the impedance of the main line, however, especially at relatively high frequencies.

It is known from U.S. Pat No. 2,657,362 for, for example, the impedance of an antenna to be matched to a different impedance by means of a mechanically varied combination of inductances and capacitances.

One object of the present invention is thus, against the background of the prior art of this generic type that has just been mentioned, to provide an improved circuit for power splitting, in particular an improved variable circuit for splitting or joining radio-frequency powers.

According to the invention, the object is achieved in accordance with the features specified in claim 1. Advantageous embodiments of the invention are specified in the dependent claims.

The circuit arrangement according to the invention is not only novel but, in terms of its overall structure and with regard to the advantages which can be achieved by it, is highly surprising. This is because one preferred embodiment of the circuit arrangement according to the invention makes it possible to achieve a variable power split without the input impedance varying in the process. According to the invention, this is achieved by a combination of variable coupling capacitances and a variable spur line, in which case both elements can be varied in a preferred manner by means of a common control element.

The power split is in this case preferably implemented such that a further line, which is capacitively coupled, branches off from a continuous RF line at a defined point. In this case, a transformation is carried out for the resistance matching at the input port or sum port, without this having—as mentioned—any consequential effect on, or causing any change to, the input impedance. Frequency compensation or frequency predistortion is carried out on the output branch. According to the invention, the power split can now be varied by moving, without any problems, an adjustment or movement element which is provided, to be precise without any reaction on the input impedance. Now, according to the invention, not only different type appliances but only one type, which is adjustable differently, are required for different power division ratios.

The circuit arrangement according to the invention can thus be installed for the most different forms of power branches in an RF broadband network, for example in the case of signal transmission in a building, for the various power branches in the individual storeys, building complexes, etc. In this case, the desired power split can be set without any problems just by rotating an adjustment element such that it corresponds to the power branch to be provided. If, furthermore, it is remembered that a large number of distribution panels are normally required for the wiring in a building, in order to split the signals that are fed in (for example in the cellar) between a large number of lines and in order, for example, possibly once again to carry out a power split between different branch lines, possibly all having different proportions of the power, in the individual storeys of a building, then the advantages according to the invention become even clearer. This is because, according to the invention, only a single circuit device is required for, in particular, continuously variable power splitting, which can in each case be set without any problems for the particular requirements, thus now making it possible, without any problems, to compensate for different cable lengths, cable attenuations, etc.

The power split according to the invention is preferably carried out using a compensating element which is arranged in a variable position. Varying the position varies the output of power into the branching line and, in the process according to the invention, at the same time compensates for the resistance change caused by the output variation. The compensating element, whose position can be varied mechanically, may be electrically conductive, but need not be. For example, it is just as possible to use a dielectric compensating element.

In one particularly preferred embodiment of the invention, the adjustment element may in this case be arranged in an axial extension for the branching line, with the main line, which runs between the input port and the further output port (that is to say between the sum port and the further individual port) being arranged transversely with respect to it.

The desired varied output can preferably be achieved by means of a mechanically adjustable probe, whose axial position can be varied, for example, by radial twisting.

However, by way of example, the compensating element may also be adjusted differently by means of some other type of adjustment mechanism. For this purpose, a further preferred exemplary embodiment provides for the control element to have the capability to be moved linearly on the circuit housing. The adjustment movement is in this case preferably carried out in the axial longitudinal direction of the circuit housing. The adjustment movement, that is say preferably the linear adjustment movement of the compensating element, can be produced and implemented via this adjustment movement, preferably internally in the adjustment element, with the adjustment movement of the compensating element being at right angles to the adjustment movement of the control element. The overall arrangement has the further advantage that, for example, an easily visible scale can be fitted, in which case it is possible to read the current power split setting exactly, as a function of the movement position of the adjustment element.

Finally, the step-up ratio between the control element and the compensating element may also be produced non-linearly, if this is desired. Otherwise, a linear step-up ratio can be achieved at any time.

The bandwidth of the output unit may be very wide, for example 45%.

The circuit arrangement according to the invention may be designed to be coaxial. However, it may also be implemented by means of discrete components, or using board technology.

It should be noted, merely for the sake of completeness, that the circuit according to the invention may also have a number of variable output elements in order to form an n-tuple distribution panel.

The circuit according to the invention for splitting or for joining radio-frequency powers, having a main line or main path (7) which is connected between an input port (1) and a first output port (3), and having a branch line (11) which branches off from the main line at a branching point (9) and leads to a second output port (5) is thus preferably distinguished in that a compensating element (61) is provided which is, in particular, adjustable, or can be installed and removed differently, and which can be varied by varying the capacitance of at least one capacitor (C₂, C₃), which is connected in the branch line (11), and/or by varying the electrical length of a spur line (37) which is coupled to the branch line (11), such that the variable magnitude of the power being tapped off at the same time also makes it possible to compensate for the resistance change caused by the change in the power split.

The invention will be explained in more detail in the following text with reference to the drawings, in which, in detail:

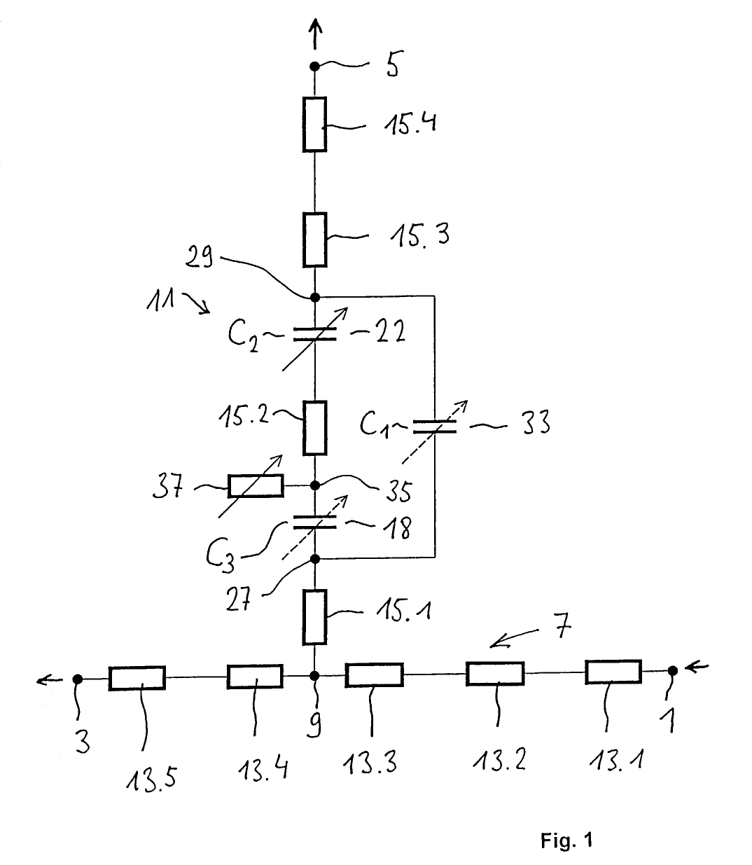

FIG. 1 shows an equivalent circuit according to the invention with discrete elements, in order to explain the methods of operation of the design of a circuit according to the invention for splitting or joining radio-frequency powers;

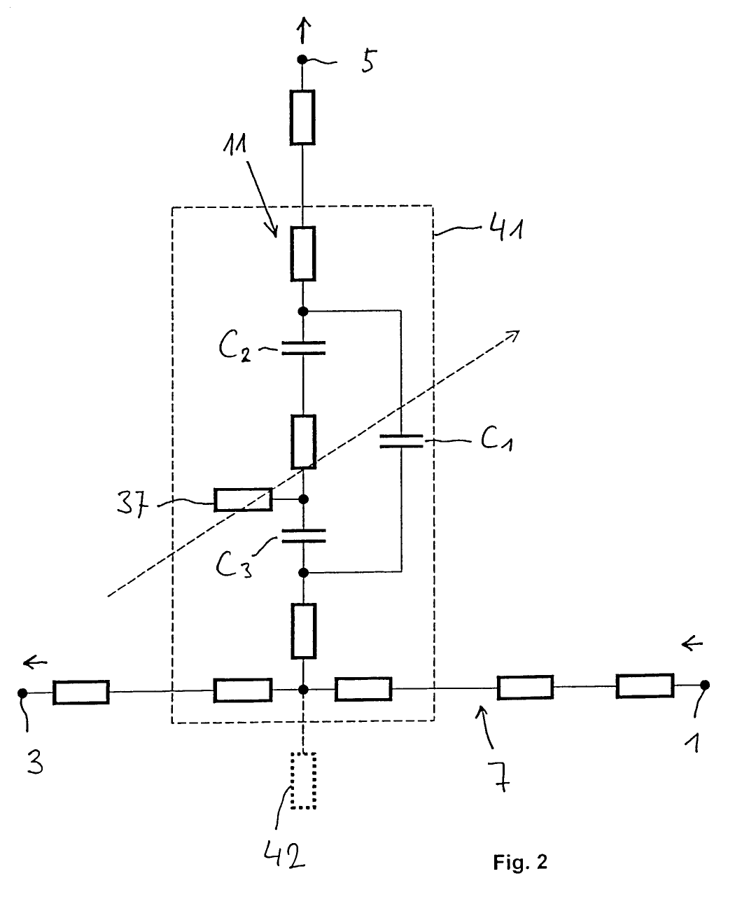

FIG. 2 shows an exemplary embodiment, which essentially corresponds to FIG. 1, and which is suitable for variable, broadband power splitting, in which a common control element is provided in order to produce the different power split;

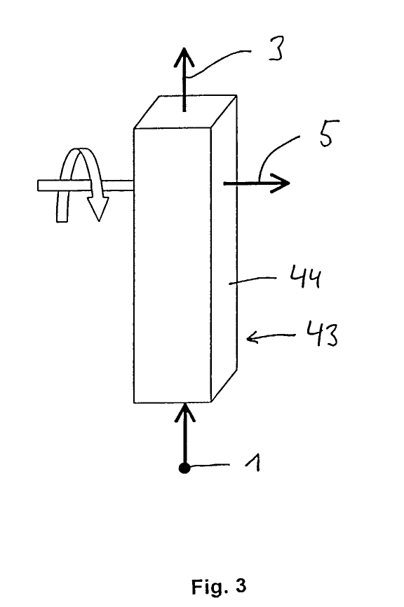

FIG. 3 shows a schematic illustration in order to explain one specific exemplary embodiment relating to a coaxial circuit design;

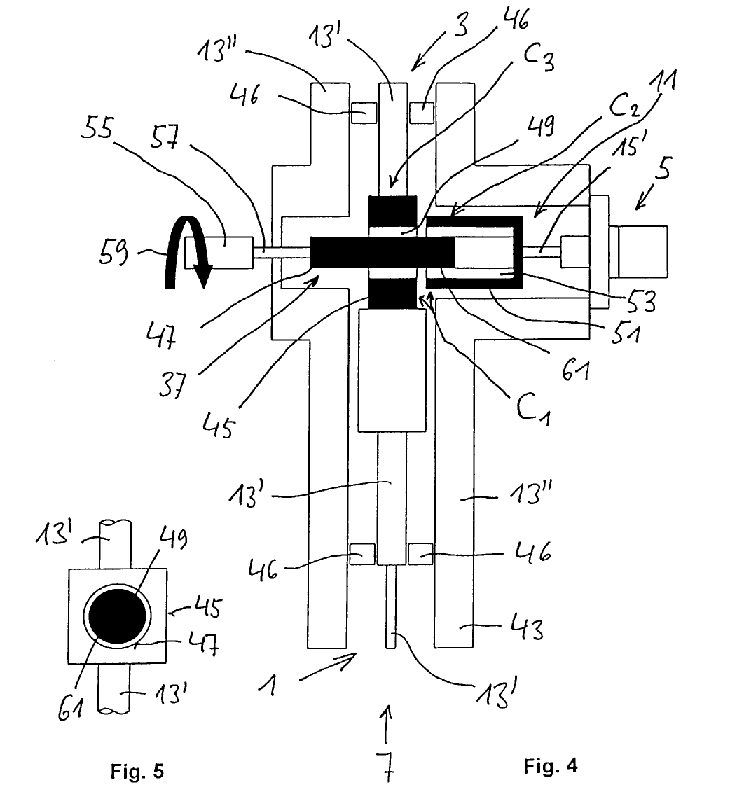

FIG. 4 shows a schematic section illustration through an exemplary embodiment according to the invention, with a corresponding basic illustration as in FIG. 3;

FIG. 5 shows an illustration of a detail of a cross section through the thickened inner conductor section in FIG. 4, with the transverse hole incorporated there;

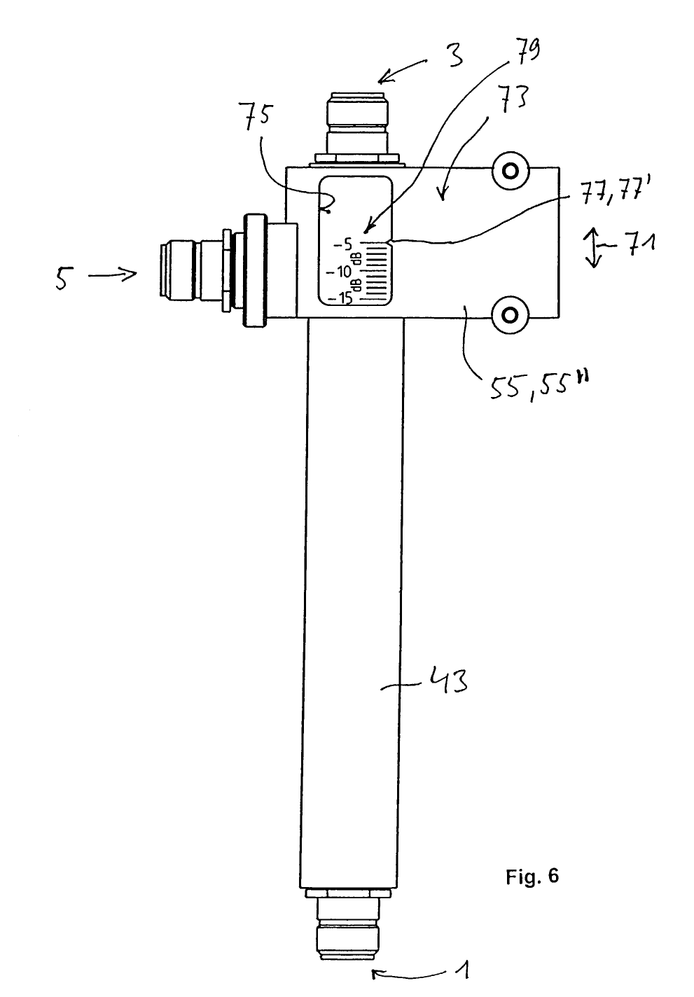

FIG. 6 shows a schematic side view of the appliance according to the invention for power splitting, with the control element in a first adjustment position;

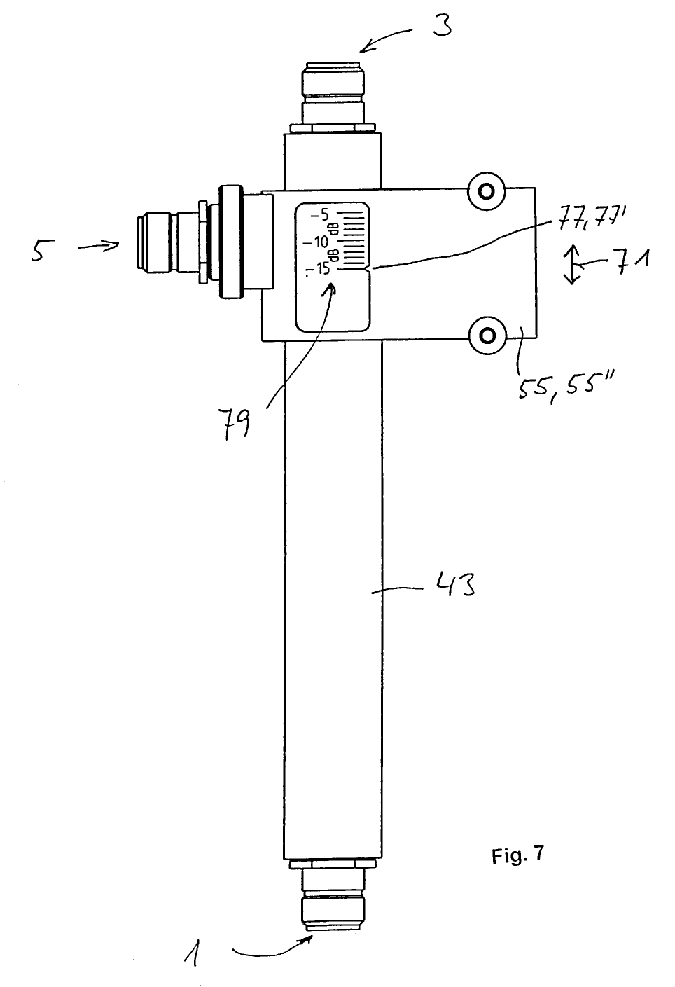

FIG. 7 shows a side view corresponding to FIG. 6, in which the control element is located in a different position to that shown in FIG. 6, in order to achieve a different power split;

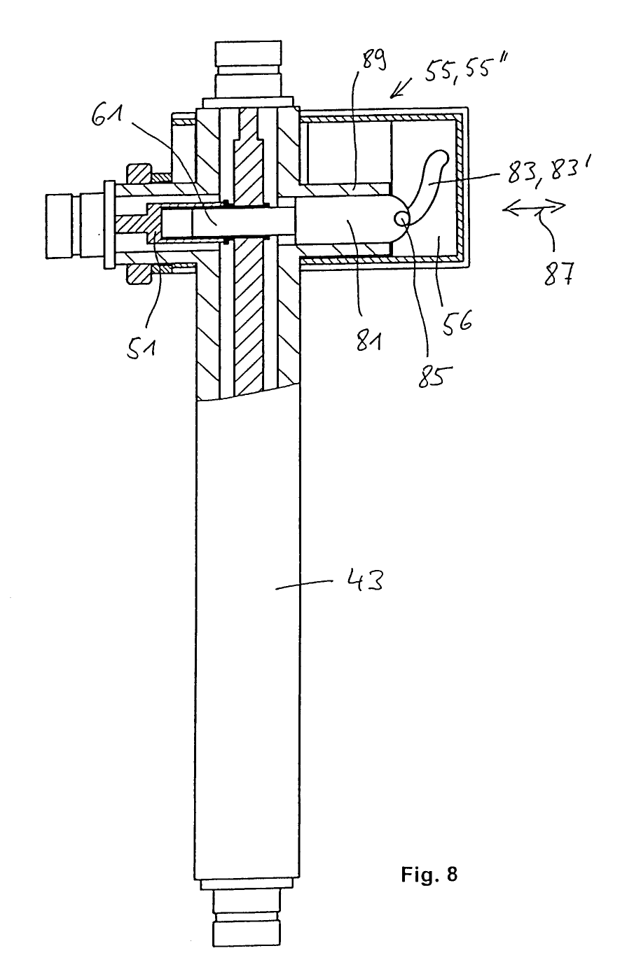

FIG. 8 shows a side view, corresponding to that in FIG. 6, of the appliance according to the invention, partially in the form of a longitudinal section;

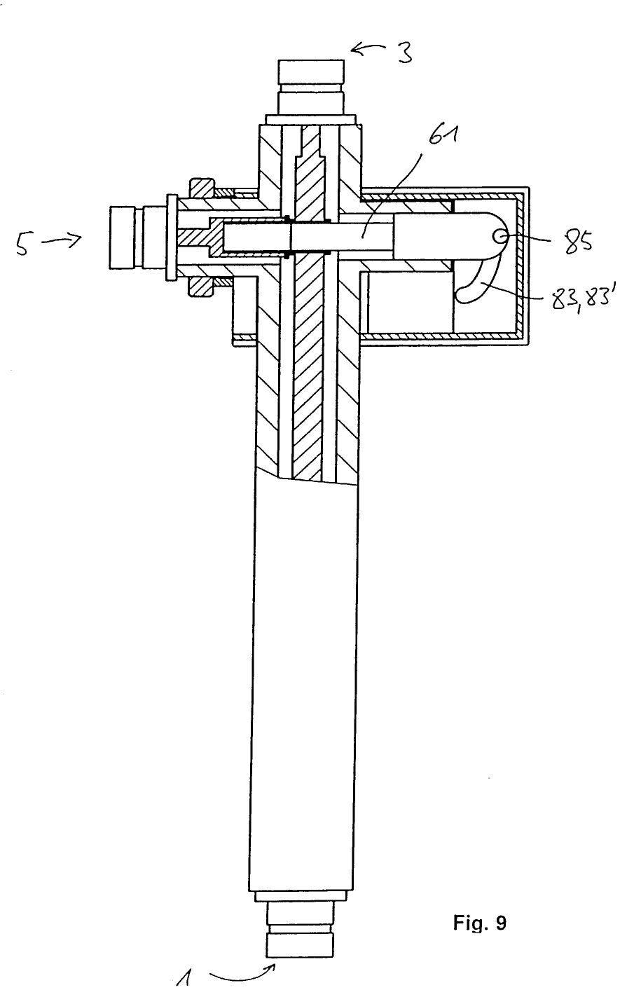

FIG. 9 shows a side view, corresponding to FIG. 7, of the appliance according to the invention for power splitting, corresponding to the second switch position shown in FIG. 7, but shown partially in the form of a longitudinal section; and

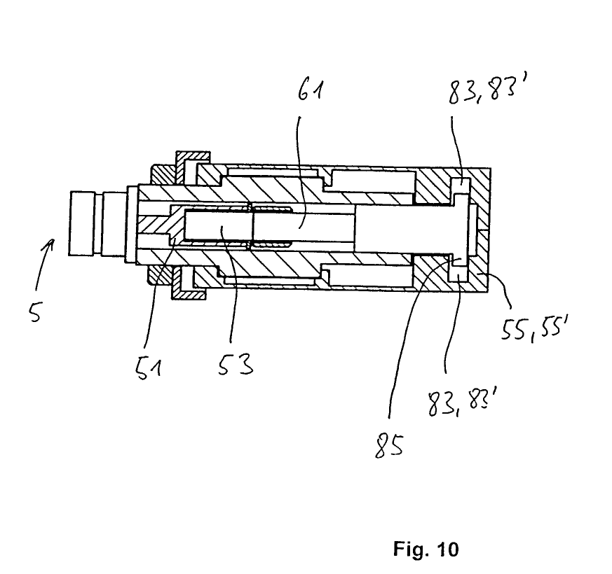

FIG. 10 shows a horizontal cross-sectional view, at right angles to the section views shown in FIGS. 8 and 9, in the switch position shown in FIGS. 6 and 8.

FIG. 1 shows an equivalent circuit of a variable, broadband power splitting circuit, on the basis of which the fundamental principle will be explained.

The circuit in this case comprises a first input or sum port 1 and a first output or individual port 3, as well as a second output or individual port 5.

As a rule, the so-called main line 7 (main path) is provided between the input port and the first output port 3, and a branch line 11 branches off from it at a branching point 9. A power which is less than 50% of the total power fed in at the input 1 is normally tapped off at the second output port 5.

The system impedance between the input port 1 and the branching point 9 in the main line 7 is 50 Ω.

In principle, the main line 7 comprises one or more series-connected RF lines 13, that is to say RF line sections 13.1, 13.2, . . . to 13.5 in the illustrated exemplary embodiment. The branch line 11 likewise comprises a coaxial line with a first RF line section 15.1, a capacitor 18 which is also denoted by the identification C₃, a downstream further RF line section 15.2, a further capacitor 22 which is also identified as the capacitor C₂, and further downstream RF line sections 15.3, 15.4, etc.

A first coupling point 27 is provided between the first RF line section 15.1 and the first capacitor 18, and a second coupling point 29 is provided between the further capacitor 22 and the downstream RF line section 15.3, between which a capacitor 33, which is also sometimes identified as the capacitor C₁ in the following text, is connected in a parallel branch 31.

An open spur line 37 is provided between the capacitor 18 and the RF line section 15.2, at the branching point 35 provided there.

The capacitors 18, 22 which have been mentioned and the electrically effective length of the spur line 37 are each in the form of adjustable, variable components. The capacitor connected in the parallel branch 31 may also be in the form of a variable capacitor, but need not be.

A common adjustment logic device or mechanism which may be provided makes it possible to ensure that, by jointly adjusting the variable capacitors and varying the length of the spur line 37, the RF power which is tapped off at the second output 5 can be set and adjusted variably and continuously, with the power which is produced at the first output 3 being reduced appropriately, corresponding to the proportion of the power which is tapped off. The adjustment process is in this case carried out without any effect on or change to the input impedance of the input 1. Furthermore, appropriate resistance predistortion is carried out, in order in this way to achieve the desired resistance compensation, overall.

FIG. 2 shows a further equivalent circuit for the embodiment shown in FIG. 1, for variable, broadband power splitting. In this case, the unit 41 is represented by dashed lines and, by means of a common control element (symbolized by the common arrow crossing the unit 41) makes it possible to set a different power split.

The dots at the junction point 9 in FIG. 2 likewise show that an additional spur line 42 for resistance matching may also be provided, if required, here.

The schematic design of an exemplary embodiment, which will be explained in greater detail in the following text with reference to FIGS. 4 and 5, of a circuit according to the invention and using a coaxial design will be explained with reference to FIG. 3.

The housing 43 of the circuit arrangement in this case comprises, for example, a quadrilateral tube with a hollow cylindrical interior as the outer conductor 13″, through which an inner conductor 13′, in the form of a rod, is passed. A corresponding coaxial socket can thus be arranged at both the input port 1 and at the first output port 3, on the opposite end faces, whose inner conductors are connected to the inner conductor 13′, and whose outer conductors are connected to the outer conductor 13″, of the circuit arrangement.

The second output port 5 is provided in the vicinity of the first output port 3 on the side 44 adjacent to the opposite end face, and may likewise once again be in the form of an RF connection with an appropriate RF socket, as is also shown in greater detail in the schematic cross-sectional view in FIG. 4.

It can be seen from the schematic cross-sectional view in FIG. 4 that the main line 7 comprises the coaxial tube 43 which has been mentioned, with the outer conductor 13″ forming the housing 43 of the circuit arrangement, and, in the interior, the inner conductor 13′, which is DC-isolated from it, being passed through it as a metallically conductive rod. To this end, the electrically conductive metallic rod which is used as the inner conductor 13′ is mounted and held at least in the region of the input port 1 and of the first output port 3 at the end of the main line 7 in corresponding insulating supports 46, which are preferably composed of plastic, and is thus DC-isolated from the housing.

At the level of the second output port 5, the electrically continuous inner conductor or rod 13′ of the main line 7 has a thickened section 45 with a transverse hole 47, within which, in the illustrated exemplary embodiment, an insulator 49 is incorporated, which is in the form of a sleeve and is preferably composed of plastic. As can be seen from the detail cross-sectional illustration (rotated through 90°) in FIG. 5, this means that there is no interruption in the conductivity of the inner conductor 13′.

The inner conductor 15′, which is in the form of a rod, on the coaxial connecting line or of the coaxial connection for the second output port 5 is provided such that it is axially aligned with the transverse hole 47 and has, adjacent to the transverse hole 47 in the inner conductor 13′ of the main line 7, an end section 51 which is in the form of a sleeve or pot and which, in the illustrated exemplary embodiment, is likewise once again provided on the inside with a hollow cylindrical insulator 53, preferably composed of plastic.

Axially opposite on the other side of the outer conductor or housing 43, there is a control element 55, illustrated with a spindle 57 in the illustrated exemplary embodiment, in order to push a compensating element 61 increasingly further in or back in the axial direction by twisting as shown by the illustrated arrow 59. The control element 55 with the spindle 57 are in this case not electrically conductively coupled, at least not to the outer conductor 13″. The compensating element 61, which is metallic in the illustrated exemplary embodiment, is thus moved axially differently via the spindle 57, with the compensating element 61 in this case passing through the hollow cylindrical thickened section 45 of the inner conductor 13′ of the main line 7 and engaging to a different extent in the hollow cylindrical inner conductor 15′, which is DC-isolated from the inner conductor 13′ of the main line.

The capacitor C₃ (18) which has been mentioned is formed by the hollow cylinder or body 45 (which is in the form of a sleeve) which is part of the inner conductor 13′ of the main line 7, and by the cylindrical compensating element 61 which passes through this body 45 that is in the form of a sleeve. Since the compensating element also engages to a different extent in the further body 51, which is in the form of a sleeve or socket, and is aligned with the body 45 that is in the form of a sleeve, the further capacitor C₂ (22) is formed between the compensating element 61 and this body 51 that is in the form of a sleeve.

Finally, the capacitor C₁ (33), which has likewise already been mentioned, is formed by the two bodies 45 (which is electrically conductively connected to the inner conductor 13′ of the main line 7), which are in the form of sleeves and are DC-isolated from one another, and to the body 51 (which is electrically connected to the inner conductor 15′ of the branch line 11), which is in the form of a sleeve and is axially at a distance from the former.

As mentioned, the compensating element can be adjusted axially by twisting the adjustment element, thus varying the capacitor C₃ and, in particular, C₂. Since the axial distance between the two bodies 45, 51 which are in the form of sleeves does not vary, the capacitor C₁ which is formed between these components is not variable in this embodiment. The electrically effective layer of the open spur line 37 is also varied as appropriate in this case by turning the compensating element in and out differently as appropriate, with the electrical length of the spur line 37 becoming shorter the further the compensating element 61 engages in the corresponding bodies 51, which are in the form of sleeves, of the spur line.

Instead of the electrically conductive compensating element 61, a non-conductive compensating element 61 may also be used, which furthermore offers the advantage that it is then always possible to dispense with the insulators which have been mentioned in the interior of the adjustment elements 45, 51, which are in the form of sleeves or pots.

A power splitter, which is explained in a corresponding manner, has a broadband design and can be adjusted variably as required can be used without any problems in a broadband RF range from, for example, 800 MHz to 2200 MHz. The difference in the power split ΔP between the output port 3 and 5 may in this case amount to values from 5 dB to 20 dB.

The exemplary embodiment has been explained with reference to an open spur line 37. However, a closed spur line 37 is also possible, at least in certain situations.

A more specific exemplary embodiment will now be described with reference to FIGS. 6 to 10, which differs from the previous exemplary embodiments primarily in that the control element 55 is not in the form of a control element 55′ which can rotate.

A corresponding appliance according to the invention for power splitting is shown in the form of a side view in FIG. 6, with the housing 43, which has a square cross section and extends in the axial longitudinal direction between the input port 1 and the input and output port 3.

At the level of the second output port 5, which is aligned transversely with respect to it, the linearly adjustable control element 55 is shown, which is cuboid in shape and in this case engages around the housing 43, which extends axially. This cuboid control element 55″ can be moved along the illustrated arrow 71 in the longitudinal direction of the housing 43, and is in this case shown in its one end position in FIG. 6, and in FIG. 7 in its other extreme or end position, which is opposite the other end position.

The cuboid control element housing 55″ in this case has on its one control element face 73 a recess which is, for example, rectangular, or a corresponding viewing area, with this recess or this viewing area 75 having an associated adjustment or reading device 77, in the illustrated exemplary embodiment in the form of a projecting tab 77′. Underneath the viewing area 75, that is to say the recess 75, a scale 79 is fitted externally on that housing wall 43′ of the housing 43 which is located underneath. Depending on the axial adjustment movement of the control element 55′, it is now possible to read exactly on the scale 79 how the power distribution is being implemented on the basis of the setting of the control element 75′, at the two recesses 3 and 5.

FIGS. 8 to 10 show the control mechanism, showing the corresponding appliance, partially in section.

It can be seen from the section illustrations in FIGS. 8 and 9 that an insulator 53, which is in the form of a sleeve, is accommodated in the sleeve or in the end section 51, which is in the form of a pot, along which insulator 53 the compensating element 61 can be moved axially, transversely with respect to the axial direction of the housing 53—as discussed with reference to the previous exemplary embodiments. The axial adjustment movement of the compensating element 61 is produced via a transmission element 81 which is in the form of a connecting stub in the illustrated exemplary embodiment, is axially firmly connected to the compensating element 61 and can be moved together with this compensating element 61 with respect to the end section 51, which is in the form of a sleeve or pot.

As can be seen from the illustration in FIGS. 8 and 9, a slotted guide 83 in the form of a guide groove 83′ is incorporated internally on a front and rear side wall section 56 in the control element 55″, which can be moved in the direction of the arrow 71, in which guide groove 83′ a guide pin 85 engages, which projects transversely with respect to the guide groove 83′ and is formed on or is attached to the transmission element 81.

An adjustment movement of the cuboid control element 55′ in the axial direction 71, that is to say in the axial longitudinal direction of the housing 43, necessarily results in an adjustment movement at right angles to this, namely in the adjustment direction 87. This is because the guide pin 85, which is held via the transmission element 81, cannot cope with an axial longitudinal movement direction corresponding to the illustrated arrow 71 and is held by the corresponding adjustment movement of the control element 55 such that it follows the respective position of the guide groove 83′, as a result of which the transmission element 81, and hence also the compensating element 61, necessarily carries out the desired adjustment movement in the direction of the illustrated arrow 87. The transmission element 81 is thus guided in a sleeve 89.

In contrast to the illustrated exemplary embodiment, the slotted guide 83 or the guide groove 83′ may be designed to be linear. This results in a linear step-up ratio. The step-up ratio depends on the groove gradient and may, for example, be in the order of magnitude of approximately 1:2. The slotted guide or the guide groove may, however, also be designed to be curved, as is shown in the exemplary embodiment in FIGS. 8 and 9, as a result of which a corresponding axial adjustment movement in the direction of the arrow 71 is changed to an entry movement or backward movement, of a different extent, of the compensating element 61 in the hollow or in the pot-shaped end section 51.

Said scale 79 must then be designed to match the stepup ratio and the capacitor effect in order in this way to clearly read what the power split setting is.

1. A circuit for splitting or for joining radio-frequency powers, having a main line or main path (7) which is connected between an input port (1) and a first output port (3), and having a branch line (11) which branches off from the main line at a branching point (9) and leads to a second output port (5), characterized in that a spur line (37) is provided, which is coupled to the branch line (11) and whose electrical length can be varied such that the resistance change caused by the change to the power split can also be compensated for by the change to the magnitude of the power which is tapped off.

2. The circuit as claimed in claim 1, characterized in that, in order to compensate for the resistance change as a function of the power which is tapped off, a compensating element (61) is provided which, in particular, can be adjusted or can be preselected differently and/or can be fitted or removed, and which is preferably a part of at least one capacitor (C₂, C₃) which is connected to a branch line (11), or is coupled to such a part.

3. The circuit as claimed in claim 2, characterized in that the compensating element (61) is designed such that, when the proportion of the power which is tapped off is changed, the electrical length of the spur line (37) which is coupled to the branch line (11) is changed at the same time in order to compensate for the resistance change which is associated with this.

4. The circuit as claimed in claims 1 to 3, characterized in that at least two variable capacitors (C₁, C₂, C₃) are provided in the branch line (11), and in that the capacitances can be varied by varying a common control element or compensating element (61).

5. The circuit as claimed in one of claims 1 to 4, characterized in that at least two series-connected capacitors (C₃, C₂) are provided in the branch line (11), whose capacitances can be varied by varying the axial position of the compensating element (61).

6. The circuit as claimed in one of claims 1 to 5, characterized in that the inner conductor (13′) of the main line (7) has a section (45) which is provided with a transverse hole (47), axially offset with respect to which, and DC-isolated from it, a further body is provided which is in the form of a sleeve and is part of the inner conductor (15′) of the branch line (7), in which case the compensating element (61) which passes through the two bodies (45, 51) in the form of sleeves can be varied by varying the capacitance of the capacitors (C₂, C₃, C₁).

7. The circuit as claimed in one of claims 1 to 6, characterized in that the compensating element (61) is electrically conductive.

8. The circuit as claimed in one of claims 1 to 7, characterized in that the compensating element (61) is electrically non-conductive.

9. The circuit as claimed in claim 7 or 8, characterized in that the compensating element (61) is isolated from the bodies (45, 51) in the form of sleeves, producing a separating gap, and/or is DC-isolated by using an insulator which is provided on the compensating element (61) and/or on the inside of the bodies (45, 51) which are in the form of sleeves, and is preferably composed of plastic.

10. The circuit as claimed in one of claims 1 to 9, characterized in that the end axial separation between the two bodies (45, 51) which are in the form of sleeves is constant, can be preselected or can be varied.

11. The circuit as claimed in one of claims 1 to 10, characterized in that the compensating element (61) is connected to an adjusting body, which is provided in an axial extension of the branch line (11), on the opposite side from the main line (7).

12. The circuit as claimed in one of claims 1 to 11, characterized in that the compensating element (61) is connected to a spindle drive, via which it can be moved axially.

13. The circuit as claimed in one of claims 1 to 12, characterized in that the spindle drive is arranged on the housing (43) of the coaxial main line (7), on the opposite side to the branch line (15).

14. The circuit as claimed in one of claims 1 to 11, characterized in that the compensating element (61) can be moved by means of a linearly movable control element (55, 55″).

15. The circuit as claimed in claim 14, characterized in that the compensating element (61) can be moved transversely, that is to say in particular with an adjustment direction (87) which runs at right angles to the movement direction (71) of the control element (55, 55″).

16. The circuit as claimed in claim 14 or 15, characterized in that the control element (55′) has a slotted and/or guide groove (83, 83′) which interacts with a guide device, which interacts with it, or with a guide pin (85), such that a linear adjustment movement of the control element (55′) is converted to a linear adjustment movement of the compensating element (61).

17. The circuit as claimed in claim 16, characterized in that the guide device is, in particular, in the form of a guide pin (85) on a transmission element (81), which is connected to the compensating element (61) and can be moved together with it.

18. The circuit as claimed in claim 16 or 17, characterized in that the transmission element (81) is in the form of a connecting stub, and is preferably guided, and can be moved axially, in a guide device (89) which is in the form of a sleeve.

19. The circuit as claimed in one of claims 1 to 18, characterized in that the step-up ratio between the control element (55, 55″) and the adjustment movement of the compensating element (61) is designed such that they are proportional to one another.

20. The circuit as claimed in one of claims 1 to 19, characterized in that the adjustment movement of the control element (55, 55″) is not proportional to the axial adjustment movement of the compensating element (61).

21. The circuit as claimed in claim 20, characterized in that the slotted guide (83) or the guide groove (83′) is designed to be linear.

22. The circuit as claimed in claim 21, characterized in that the slotted guide (83) or the guide groove (83′) is designed to be curved.

23. The circuit as claimed in one of claims 1 to 22, characterized in that the control element (55) is designed with a scale (79) or an adjustment and reading device (77), which is provided with an adjustment or reading device (77) formed directly or indirectly on the housing (43), or with a scale (79), which is formed there, for reading the power split at the two output ports (3, 5).
